(19) United States
(12) Patent Application Publication
(10) Pub. No.: US 2013/0346095 A1
(43) Pub. Date: Dec. 26, 2013

(54) AUTOMATED CORRELATION OF CLINICAL FINDINGS

(71) Applicant: JUDITH BUCKLAND, WELLINGTON, FL (US)

(72) Inventor: JUDITH BUCKLAND, WELLINGTON, FL (US)

(21) Appl. No.: 13/927,000

(22) Filed: Jun. 25, 2013

Related U.S. Application Data
(60) Provisional application No. 61/663,916, filed on Jun. 25, 2012.

(51) Int. Cl. G06F 19/00

(52) U.S. Cl. CPC G06F 19/36
USPC 705/2

(57) ABSTRACT

Arrangements described herein relate to correlation of clinical findings. A first list presented can include a plurality of candidate first clinical findings that potentially correspond to a first modality of testing performed on a patient. Responsive to receiving a first user input selecting at least one of the candidate first clinical findings, that candidate first clinical finding can be selected as a first clinical finding corresponding to the first modality of testing. A second list presented can include a plurality of candidate second clinical findings that potentially correspond to a second modality of testing performed. Responsive to receiving a second user input selecting at least one of the candidate second clinical findings, that candidate second clinical finding can be selected as a second clinical finding corresponding to the second modality of testing. A determination can be made whether the first clinical finding and the second clinical finding clinically correlate.

### CROSS-REFERENCE TO RELATED APPLICATIONS

This application claims the benefit of U.S. Provisional Patent Application No. 61/663,916, titled GENERATING A CORRECTIVE ACTION PLAN USING AUTOMATED CLINICAL CORRELATION, and filed Jun. 25, 2012, the entirety of which is fully incorporated herein by reference.

### BACKGROUND

Arrangements described herein relate to correlation of clinical findings.

Health care organizations are held to very high levels of accountability by their peers and the general public. To ensure that medical services provided to patients meet or exceed expectations, Medicare carriers and private insurers oftentimes require that medical organizations providing certain types of medical services, such as diagnostic testing, obtain proper accreditation as a necessary condition to receive reimbursement for the services rendered. Examples of such services include unitrasound, angiography, echocardiography, nuclear medicine testing, positron emission tomography (PET), magnetic resonance imaging (MRI), vascular testing, cardiac catheterization, surgical analysis, computed tomography (CT) scanning, dental CT services and autopsies. Various organizations provide such accreditation. Examples of such organizations include, but are not limited to, the Intersocietal Accreditation Commission (IAC), the American College of Radiology (ACR®), The Joint Commission, Accreditation for Cardiovascular Excellence (ACE) and the American Medical Association (AMA).

### BRIEF SUMMARY

One or more embodiments disclosed within this specification relate to correlation of clinical findings.

A method can include presenting a first list including a plurality of candidate first clinical findings that potentially correspond to a first modality of testing performed on a patient. Responsive to receiving a first user input selecting at least one of the candidate first clinical findings, that candidate first clinical finding can be selected as a first clinical finding corresponding to the first modality of testing performed on the patient. A second list can be presented. The second list can include a plurality of candidate second clinical findings that potentially correspond to a second modality of testing performed on the patient. Responsive to receiving a second user input selecting at least one of the candidate second clinical findings, that candidate second clinical finding can be selected as a second clinical finding corresponding to the second modality of testing performed on the patient. The first clinical finding and the second clinical finding can be processed, via a processor, to determine whether the first clinical finding and the second clinical finding clinically correlate. An indication of whether the first clinical finding and the second clinical finding clinically correlate can be output.

A system includes a processor programmed to initiate executable operations. The executable operations can include presenting a first list including a plurality of candidate first clinical findings that potentially correspond to a first modality of testing performed on a patient. Responsive to receiving a first user input selecting at least one of the candidate first clinical findings, that candidate first clinical finding can be selected as a first clinical finding corresponding to the first modality of testing performed on the patient. A second list can be presented. The second list can include a plurality of candidate second clinical findings that potentially correspond to a second modality of testing performed on the patient. Responsive to receiving a second user input selecting at least one of the candidate second clinical findings, that candidate second clinical finding can be selected as a second clinical finding corresponding to the second modality of testing performed on the patient. The first clinical finding and the second clinical finding can be processed, via a processor, to determine whether the first clinical finding and the second clinical finding clinically correlate. An indication of whether the first clinical finding and the second clinical finding clinically correlate can be output.

A computer program product includes a computer-readable storage medium having program code stored thereon. The program code is executable by a processor to perform a method. The method can include presenting a first list including a plurality of candidate first clinical findings that potentially correspond to a first modality of testing performed on a patient. Responsive to receiving a first user input selecting at least one of the candidate first clinical findings, that candidate first clinical finding can be selected as a first clinical finding corresponding to the first modality of testing performed on the patient. A second list can be presented. The second list can include a plurality of candidate second clinical findings that potentially correspond to a second modality of testing performed on the patient. Responsive to receiving a second user input selecting at least one of the candidate second clinical findings, that candidate second clinical finding can be selected as a second clinical finding corresponding to the second modality of testing performed on the patient. The first clinical finding and the second clinical finding can be processed, via a processor, to determine whether the first clinical finding and the second clinical finding clinically correlate. An indication of whether the first clinical finding and the second clinical finding clinically correlate can be output.

### BRIEF DESCRIPTION OF THE DRAWINGS

FIG. 1 is a block diagram illustrating a system for automatically correlating clinical findings in accordance with one embodiment disclosed within this specification.

FIG. 2 depicts a view presented by a user interface of a communication device in accordance with one embodiment disclosed within this specification.

FIG. 3 is a flow chart illustrating a method of automatically correlating clinical findings in accordance with another embodiment disclosed within this specification.

FIG. 4 is a block diagram of a processing system that automatically correlates clinical findings in accordance with one embodiment disclosed within this specification.

### DETAILED DESCRIPTION

While the specification concludes with claims defining features of the invention that are regarded as novel, it is believed that the invention will be better understood from a consideration of the description in conjunction with the drawings. As required, detailed embodiments of the present arrangements are disclosed herein; however, it is to be understood that the disclosed arrangements are merely exemplary arrangements, which can be embodied in various forms. Therefore, specific structural and functional details disclosed herein are not to be interpreted as limiting, but merely as a basis for the claims and as a representative basis for teaching one skilled in the art to variously employ the present arrangements in virtually any appropriately detailed structure. Further, the terms and phrases used herein are not intended to be limiting but rather to provide an understandable description of the arrangements.

As will be appreciated by one skilled in the art, aspects of the present arrangements may be embodied as a system, method or computer program product. Accordingly, aspects of the present arrangements may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present arrangements may take the form of a computer program product comprising one or more computer-readable storage medium(s) having computer-readable program code stored thereon.

Examples of a computer-readable storage medium include, but are not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. As defined herein, the term “computer-readable storage medium” means a tangible storage medium that contains or stores program code for use by or in connection with an instruction execution system, apparatus, or device.

Aspects of the present arrangements are described below with reference to flowchart illustrations and/or block diagrams of methods, apparatus (systems), and computer program products according to arrangements described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored on a computer-readable storage medium that can direct a computer, other programmable data processing apparatus, or other devices to function in a particular manner, such that the instructions stored on the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Arrangements described herein relate to automatic correlation of clinical findings generated pursuant to medical services provided to a patient. Such correlation can be performed by a processing system having a processor configured to implement the processes and methods described. Notably, the user need not be an expert in clinical correlation. The user need only select fields corresponding to the clinical findings, and the processing system automatically determines whether these clinical findings correlate. Moreover, by automatically performing the clinical correlation, the risk of correlation error due to human error is mitigated.

The automated correlation of clinical findings can be implemented as part of a process to obtain accreditation for a medical organization and/or medical facility from an accrediting organization. For example, accrediting organizations oftentimes require that applicants for accreditation provide clinical findings and results from clinical correlations of such findings. The present arrangements facilitate generation of results from such clinical correlations, and help to ensure the accuracy of such results.

Moreover, the present arrangements provide those seeking accreditation intuitive interactive menus through which information regarding presently implemented practices/procedures can be entered and evaluated. Based on the information entered, an assessment of such practices/procedures can be generated. Such assessment can be based, at least in part, on policies established by one or more accreditation organizations.

Further, the present arrangements provide recommendations for quality improvement for those seeking accreditation whose practices/policies do not meet the policies established by the accreditation organization(s). For example, based on results from the automated correlation of clinical findings and information gathered, recommendations for improving existing policies/procedures can be recommended.

Several definitions that apply throughout this document will now be presented.

As used herein, the term “user” means a person (i.e., a human being).

As used herein, the term “clinical finding” means a finding based on a clinical analysis of results from a test performed on a patient.

As used herein, the term “pathology” means a structural or functional deviation of an organ from a normal state of the organ.

As used herein, the term “modality of testing” means a particular type of testing. In illustration, a first modality of testing may be a first type of diagnostic testing, and a second modality of testing may be a second type of diagnostic testing that is different than the first modality of testing.

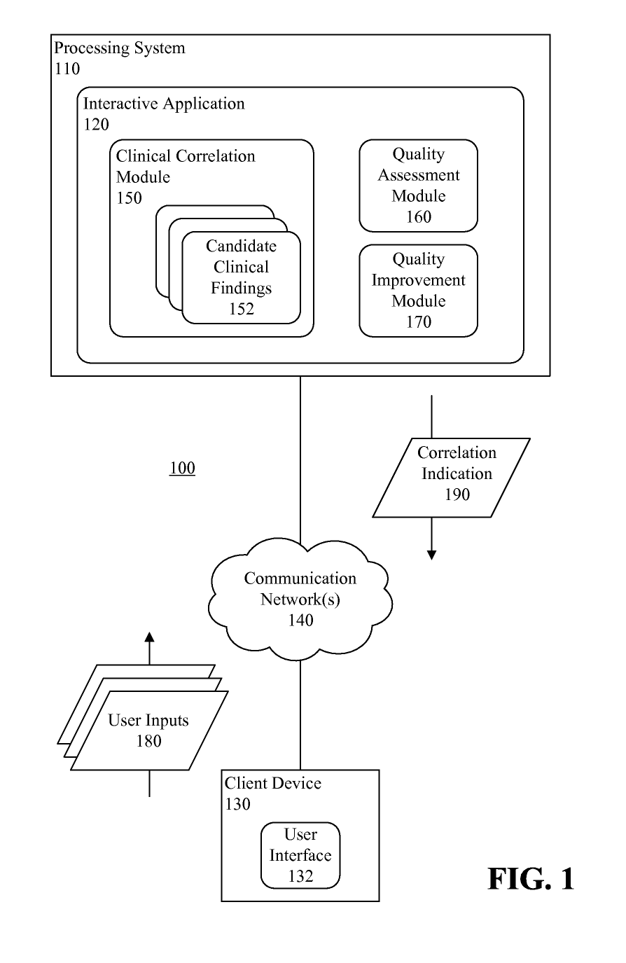

FIG. 1 is a block diagram illustrating a system 100 for automatically correlating clinical findings in accordance with one embodiment disclosed within this specification. The system can include a processing system 110 including at least one processor. The processing system can be, for example, a computer (e.g., a server, a workstation, a desktop computer, a mobile computer, a laptop computer, a tablet computer, or the like), a smartphone, a personal digital assistant, or any other processing system suitably configured to execute computer program code. The processing system 110 can be configured to execute an interactive application (hereinafter “application”) 120, which will be described herein.

In one arrangement, a user can directly interact with the processing system 110, for example via various input/output (I/O) devices, to use the application 120. Examples of such I/O devices include, but are not limited to, a pointing device (e.g., a mouse, touchpad or the like), a keyboard, a display, a touchscreen, I/O audio devices, etc. Information presented to a user can be presented by one or more of these I/O devices, and user inputs received from the user can be received by one or more of these I/O devices.

In another arrangement, the system 100 further can include at least one client device 130 communicatively linked to the processing system 110 via one or more communication networks 140. The user can establish a user session with the application 120 via the client device 130. For example, the processing system 110 can host the application 120, for instance as a web application and/or software as a service, and the client device 130 can access the processing system 110/application 120 via the communication network(s) 140. The communication network(s) 140 can be implemented as, or include, any of a variety of different networks such as a wide area network (WAN), a local area network (LAN), a wireless network, a mobile network, a Virtual Private Network (VPN), the Internet, the Public Switched Telephone Network (PSTN), or the like.

The client device 130 can include a user interface 132, for instance a web browser or other suitable interface, which presents on the client device 130 windows, menus, fields, etc. provided by the application 120, and receives user inputs. The client device can be, for example, a computer (e.g., a workstation, a desktop computer, a mobile computer, a laptop computer, a tablet computer, or the like), a smartphone, a personal digital assistant, or any other processing system comprising a processor suitably configured to execute the user interface 132. The client device also can include one or more I/O devices (not shown), such as a pointing device, a keyboard, a display, a touchscreen, I/O audio devices, etc. Information presented to a user can be presented by one or more of these I/O devices, and user inputs received from the user can be received by one or more of these I/O devices. The client device 130 further can include a network adapter (not shown) configured to communicate with the processing system 110 via the communication network(s) 140.

Referring to the application 120, the application 120 can include a clinical correlation module 150, a quality assessment module 160 and a quality improvement module 170.

The clinical correlation module 150 can, responsive to user inputs 180, automatically process at least two different sets of clinical findings corresponding to respective modalities of testing performed on a patient to determine whether the clinical findings correlate. In this regard, the clinical correlation module 150 can execute suitable algorithms to perform the clinical correlation. Further, the clinical correlation module 150 can output a correlation indication 190, for example a report, indicating whether the first set of clinical findings and the second set of clinical findings clinically correlate.

Moreover, responsive to determining the first clinical finding and the second clinical finding do not clinically correlate, the clinical correlation module 150 can process the first clinical finding and the second clinical finding, using suitable algorithms, to determine a severity of a discrepancy between the first clinical finding and the second clinical finding. For instance, the clinical correlation module 150 can determine whether the discrepancy is a minor discrepancy or a major discrepancy. Further, the clinical correlation module 150 can output an indication of the severity of the discrepancy between the first clinical finding and the second clinical finding, for example within the report.

In illustration, the clinical correlation module 150 can prompt a user to identify a patient subject to at least two modalities of testing. The clinical correlation module 150 also can prompt the user to identify an organ of the patient subject to the modalities of testing. In one arrangement, the clinical correlation module 150 further can prompt the user to identify one or more structures of the organ and/or one or more portions of structures of the organ. Further, the clinical correlation module 150 can prompt the user to identify at least two modalities of testing performed on the organ for which clinical findings are to be provided.

To facilitate the process of receiving information from the user, the clinical correlation module 150 can include one or more sets of candidate clinical findings 152 and other information from which the user can choose. The candidate clinical findings 152 and other information can be presented to the user in fields of a view presented by the user interface 132, and the user can select certain ones of these in response to questions presented to the user in the view. The candidate clinical findings 152 and other information selected by the user for the modalities of diagnostic testing can be processed to determine whether the clinical findings correlate.

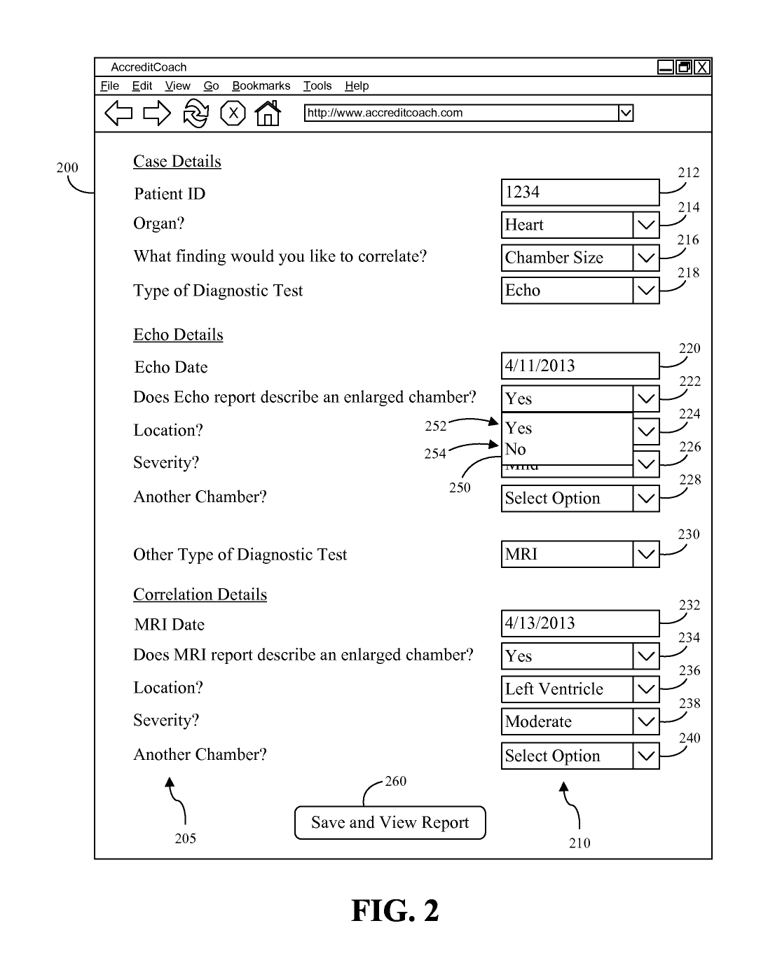

FIG. 2 depicts a view 200 presented by a user interface of a processing system in accordance with one embodiment disclosed within this specification. The user interface can, for example, be the user interface 132 of the client device 130 or a user interface of the processing system 110. The view 200 can present to the user a plurality of questions 205 corresponding to patient information and diagnostic testing performed on the patient, and a plurality of corresponding fields 210 configured to receive user inputs in response to the questions. At least a portion of the questions 205 and the fields 210 can be dynamically selected and presented in response to previous user inputs/selections. In this regard, some questions 205 and fields 210 that are presented in the view 200 can be modality specific and based on a type of organ and/or disease processes.

Moreover, many of the fields 210 can comprise, or otherwise be associated with, respective lists (e.g., drop-down menus, associated pop-up lists or windows, etc.). Each list can present a plurality of candidate answers to corresponding question posed to the user. From each list, the user can choose a particular answer to the question posed.

In illustration, the field 212 can prompt the user to identify a patient. In one arrangement, rather than entering the patient's name, another patient identifier can be used, for example a patient number, to protect the patient's identity. The field 214 can prompt the user to select an organ for which clinical findings are to be correlated. The list can include a plurality of candidate organs that potentially were tested during the first and second modalities of diagnostic testing performed on the patient. From the list, the user can select at least one of the candidate organs as the organ that was actually tested in two or more modalities of diagnostic testing performed on the patient.

Responsive to the user selecting a particular organ in the field 214, the field 216 can be presented prompting the user to identify a clinical finding (e.g., a condition) to be correlated. For example, a list of candidate conditions can be presented to the user. For example, if “heart” is selected for the field 216, the list can include “chamber size,” “LVF,” “mass-thrombus-tumor, etc.,” “septa,” “valvular heart disease,” and “other.” The present arrangements are not limited to these specific examples, however. From the list, the user can select a condition, and the selected condition can be entered into the field 216.

The field 218 can be presented to the user prompting the user to identify a type of a first modality of testing performed on the patient. For example, a list of candidate modalities of testing can be presented to the user. Responsive to the user selecting a first modality of testing from a respective list of candidate modalities of diagnostic testing, the fields 220, 222 can be presented. The field 220 can prompt the user to enter or select the date of the diagnostic test selected in field 218. The field 222 can present to the user a list 250 of candidate clinical findings 252, 254 selected based on the user selections for the fields 214, 216 and 218. Each candidate clinical finding 252, 254 can be a clinical finding that potentially corresponds to the modality of testing identified in field 218. Moreover, each candidate clinical finding 252, 254 can be those findings identified as can potentially corresponding to the organ identified in field 214 and the finding indicated in field 216. In illustration, if the first modality of testing is an echocardiogram performed on a heart and chamber size is being correlated, the field 222 can present a list of candidate clinical findings corresponding to the question “does Echo report describe an enlarged chamber?” In this example, the candidate clinical findings are “yes” and “no.” From the presented list 250, the user can select “yes” as the clinical finding, and this clinical finding can be entered into the field 222.

Based on the clinical finding selected for the field 222, one or more other fields 224, 226 can be presented to prompt the user to select other clinical findings and/or information based on the first diagnostic test. The candidate clinical findings presented in a respective list associated with the field 224 can be those candidate clinical findings identified as potentially corresponding to previous user selections. Similarly, the candidate clinical findings presented in a respective list associated with the field 224 can be those candidate clinical findings identified as potentially corresponding to previous user selections, including the selection entered in the field 224. For example, the fields 224, 226 can prompt a user to identify a location or structure of the organ selected in field 214, a portion of a structure, a severity of a condition, etc. From the field 228, the user can select another structure or portion of the organ, and fields similar to those described above can be presented to receive user inputs selecting corresponding information and/or clinical findings.

At some time during or after the process of selecting clinical findings and/or other information related to the first diagnostic test, the user can enter and/or select clinical findings and other information for a second modality of testing performed on the patient and organ for which the first modality of testing was performed. Such clinical findings/information can be selected in fields 230, 232, 234, 236, 238, 240 in the same manner described above.

When the user has completed selection of clinical findings/information in the fields 210, the user can indicate that the selections are complete, for example by choosing a button, menu item, selectable icon, or the like. For instance, the user can select a button 260. In response to the user selection, clinical correlation can be performed to determine whether clinical findings selected for the first modality of testing clinically correlate to clinical findings selected for the second modality of testing. For example, a determination can be made whether the clinical finding selected for the field 224 clinically correlates with clinical the clinical finding selected for the field 236. Similarly, a determination can be made whether the clinical finding selected for the field 226 clinically correlates with clinical the clinical finding selected for the field 238. Still, other clinical findings can be correlated and the present arrangements are not limited in this regard.

Referring again to FIG. 1, the clinical correlation performed by the clinical correlation module 150 can be used as part of a quality improvement program for medical organizations. In this regard, the clinical correlation module 150 can be used in conjunction with the quality assessment module 160 and the quality improvement module. In illustration, based, at least in part, on the determination of whether the clinical findings clinically correlate, the quality assessment module 160 can determine whether the first modality of testing performed on the patient and/or the second modality of testing performed on the patient satisfies one or more guidelines pertaining to the testing modalities. Such guidelines can be those issued by an accreditation organization. Further, based, at least in part, on a determination that at least one clinical finding corresponding to the first modality of testing does not correlate to at least one finding corresponding to the second modality of testing, the quality improvement module 170 can generate a recommendation that at least one procedure used to perform or analyze the first modality of testing or the second modality of testing be reviewed. The recommendation can, for example, include recommended action steps to take as part of a quality improvement program.

The quality assessment module 160 and quality improvement module 170 also can perform other processes. For example, the quality assessment module 160 can present one or more views to a user via the user interface 132. In these views, the quality assessment module 160 can ask the user a plurality of questions, and for each of these questions, prompt the user to enter and/or select answers. The questions can pertain to current practices implemented by the medical organization. In one arrangement, the answers provided by the user can be specific to a particular medical facility. The practices to which the questions are pertain can include, but are not limited to, practices implemented by a personnel department, practices implemented by human resources, ordering and purchasing, workflow logistics, administrative practices, physician practices, clerical practices, diagnostic practices, safety practices, patient care, etc.

The answers received from, or selected by, the user can be cross referenced to the standards and guidelines of a specific accreditation organization from whom the medical organization seeks to obtain accreditation. For every area for which the answers indicate the medical facility does not currently meet the required standards and guidelines, the quality assessment module 160 can provide to the medical organization recommendations. The recommendations can be provided in the form of instructions, advice, tools, resources and the like which will guide the medical organization to rectify issues that currently prevent them from meeting the required standards and guidelines. In one arrangement, the recommendations can be provided as one or more video presentations, written instructions, downloadable forms, etc.

The quality improvement module 170 can present in one or more views to a user via the user interface 132. In illustration, the quality improvement module 170 can provide a plurality of sections of information dedicated to each quality improvement measure mandated by the accreditation organization from whom the medical organization seeks to obtain accreditation. Various sections may be dedicated to clinical correlation, report review, report processing time, appropriate use criteria, variability, peer review, quality improvement meetings, staff competence, etc. The present arrangements are not limited to these examples, however.

Each quality improvement section can provide the user with resources necessary to assess a respective measure of quality within the medical facility. The user can be prompted to answer various questions, for example using yes/no answers, to navigate through an assessment of the quality improvement measure in strict adherence to the accreditation organization's standards and guidelines. Further, the quality improvement module 170 can generate summary findings, for example in a report format, based on the answers provided by the user. The quality improvement module 170 also can provide recommendations for quality improvement with the summary findings. These recommendations can include action steps to be taken as part of a quality improvement program.

The summary findings and recommendations can be stored to a suitable computer-readable storage medium by the interactive application 120. Further, the quality improvement module 170 can calculate, based on the summary findings, a value corresponding to a current level of compliance with the applicable standards and guidelines. For example, a percentage of compliance can be calculated. In illustration, if the summary findings indicate that half of the applicable standards and guidelines currently are met, the percentage of compliance can be calculated as fifty-percent.

Notably, the user providing the answers to questions presented by the quality assessment module 160 and quality improvement module 170 does not need to have any prior knowledge of the applicable standards and guidelines. Such standards and guidelines are contained in the interactive application 120. Moreover, the interactive application 120 can guide users through the accreditation process.

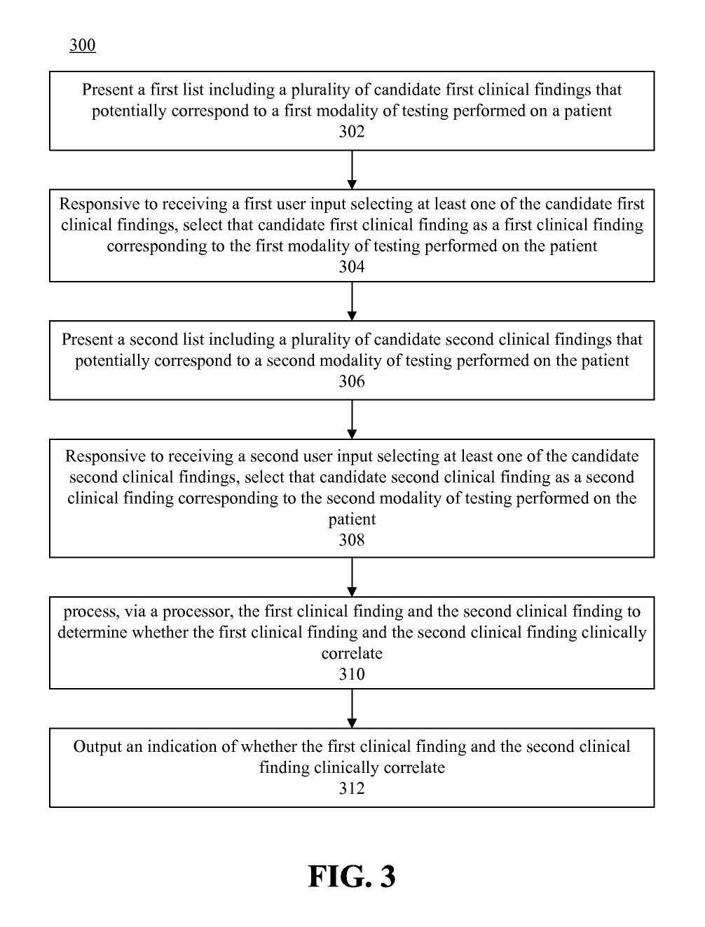

FIG. 3 is a flow chart illustrating a method 300 of automatically correlating clinical findings in accordance with another embodiment disclosed within this specification. At step 302, a first list can be presented. The first list can include a plurality of candidate first clinical findings that potentially correspond to a first modality of testing performed on a patient. At step 304, responsive to receiving a first user input selecting at least one of the candidate first clinical findings, that candidate first clinical finding can be selected as a first clinical finding corresponding to the first modality of testing performed on the patient. At step 306 a second list can be presented. The second list can include a plurality of candidate second clinical findings that potentially correspond to a second modality of testing performed on the patient. At step 308, responsive to receiving a second user input selecting at least one of the candidate second clinical findings, that candidate second clinical finding can be selected as a second clinical finding corresponding to the second modality of testing performed on the patient. At step 310, the first clinical finding and the second clinical finding can be processed, via a processor, to determine whether the first clinical finding and the second clinical finding clinically correlate. At step 312, an indication of whether the first clinical finding and the second clinical finding clinically correlate can be output.

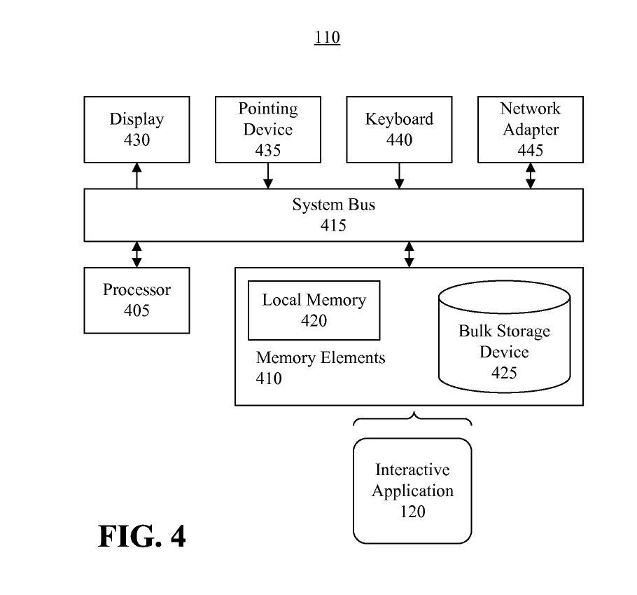

FIG. 4 is a block diagram of the processing system 110 of FIG. 1 in accordance with one embodiment disclosed within this specification. The processing system 110 can include at least one processor 405 (e.g., a central processing unit) coupled to memory elements 410 through a system bus 415 or other suitable circuitry. As such, the processing system 110 can store program code within the memory elements 410. The processor 405 can execute the program code accessed from the memory elements 410 via the system bus 415. It should be appreciated that the processing system 110 can be implemented in the form of any system including a processor and memory that is capable of performing the functions and/or operations described within this specification. For example, the processing system 110 can be implemented as a computer, a workstation, a mobile computer, a laptop computer, tablet computer, a smart phone, a personal digital assistant, a gaming device, an appliance, and so on.

The memory elements 410 can include one or more physical memory devices such as, for example, local memory 420 and one or more bulk storage devices 425. Local memory 420 refers to random access memory (RAM) or other non-persistent memory device(s) generally used during actual execution of the program code. The bulk storage device(s) 425 can be implemented as a hard disk drive (HDD), solid state drive (SSD), or other persistent data storage device. The processing system 110 also can include one or more cache memories (not shown) that provide temporary storage of at least some program code in order to reduce the number of times program code must be retrieved from the bulk storage device 425 during execution.

Input/output (I/O) devices such as a display 430, a pointing device 435 and, optionally, a keyboard 440 can be coupled to the processing system 110. The I/O devices can be coupled to the processing system 110 either directly or through intervening I/O controllers. For example, the display 430 can be coupled to the processing system 110 via a graphics processing unit (GPU), which may be a component of the processor 405 or a discrete device. One or more network adapters 445 also can be coupled to processing system 110 to enable processing system 110 to become coupled to other systems, computer systems, remote printers, and/or remote storage devices through intervening private or public networks. Modems, cable modems, transceivers, and Ethernet cards are examples of different types of network adapters 445 that can be used with processing system 110.

As pictured in FIG. 4, the memory elements 410 can store the components the interactive application 120. Being implemented in the form of executable program code, the interactive application 120 can be executed by the processing system 110 and, as such, can be considered part of the processing system 110. Moreover, the interactive application 120 is a functional data structure that imparts functionality when employed as part of the processing system 110.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one arrangement,” “an arrangement,” or similar language means that a particular feature, structure, or characteristic described in connection with the embodiment is included in at least one arrangement disclosed within this specification. Thus, appearances of the phrases “in one arrangement,” “in an arrangement,” and similar language throughout this specification may, but do not necessarily, all refer to the same arrangement.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method comprising:
presenting a first list including a plurality of candidate first clinical findings that potentially correspond to a first modality of testing performed on a patient;
responsive to receiving a first user input selecting at least one of the candidate first clinical findings, selecting that candidate first clinical finding as a first clinical finding corresponding to the first modality of testing performed on the patient;
presenting a second list including a plurality of candidate second clinical findings that potentially correspond to a second modality of testing performed on the patient;
responsive to receiving a second user input selecting at least one of the candidate second clinical findings, selecting that candidate second clinical finding as a second clinical finding corresponding to the second modality of testing performed on the patient;
processing, via a processor, the first clinical finding and the second clinical finding to determine whether the first clinical finding and the second clinical finding clinically correlate; and
outputting an indication of whether the first clinical finding and the second clinical finding clinically correlate.

2. The method of claim 1, further comprising:
responsive to determining the first clinical finding and the second clinical finding do not clinically correlate, processing the first clinical finding and the second clinical finding to determine a severity of a discrepancy between the first clinical finding and the second clinical finding; and
outputting an indication of the severity of the discrepancy between the first clinical finding and the second clinical finding.

3. The method of claim 1, further comprising:
presenting a third list including a plurality of candidate third clinical findings that potentially correspond to the first clinical finding and to the first modality of testing performed on the patient;
responsive to receiving a third user input selecting at least one of the candidate third clinical findings, selecting that candidate third clinical finding as a third clinical finding corresponding to the first modality of testing performed on the patient;
presenting a fourth list including a plurality of candidate fourth clinical findings that potentially correspond to the second clinical finding and to the second modality of testing performed on the patient;
responsive to receiving a fourth user input selecting at least one of the candidate fourth clinical findings, selecting that candidate fourth clinical finding as a fourth clinical finding corresponding to the first modality of testing performed on the patient; and
processing the third clinical finding and the fourth clinical finding to determine whether the third clinical finding and the fourth clinical finding clinically correlate.

4. The method of claim 1, further comprising:
presenting a third list including a plurality of candidate conditions that potentially correspond to the patient; and
receiving a third user input selecting at least one of the candidate conditions as a condition to be correlated between the first and second clinical findings;
wherein processing the first clinical finding and the second clinical finding to determine whether the first clinical finding and the second clinical finding clinically correlate comprises further processing the selected condition.

5. The method of claim 1, further comprising:
presenting a third list including a plurality of candidate organs that potentially were tested during the first and second modalities of diagnostic testing performed on the patient; and
receiving a third user input selecting at least one of the candidate organs as an organ that was actually tested during the first and second modalities of diagnostic testing;
wherein:
presenting the first list including the plurality of candidate first clinical findings comprises identifying candidate clinical findings that potentially correspond to the selected organ; and
presenting the second list including the plurality of candidate second clinical findings comprises identifying candidate clinical findings that potentially correspond to the selected organ.

6. The method of claim 1, further comprising:
presenting a third list including a plurality of candidate first modalities of diagnostic testing performed on the patient;
receiving a third user input selecting at least one of the candidate first modalities of diagnostic testing as the first modality of testing;
presenting a fourth list including a plurality of candidate second modalities of diagnostic testing performed on the patient; and
receiving a fourth user input selecting at least one of the candidate second modalities of diagnostic testing as the second modality of testing.

7. The method of claim 1, further comprising:
based, at least in part, on the determination of whether the first clinical finding and the second clinical finding clinically correlate, determining whether the first modality of testing performed on the patient or the second modality of testing performed on the patient satisfies at least one guideline pertaining to the first modality of testing or at least one guideline pertaining the second modality of testing.

8. The method of claim 1, further comprising:
based, at least in part, on a determination that the first clinical finding and the second clinical finding do not clinically correlate, automatically generating a recommendation that at least one procedure used to perform or analyze the first modality of testing or the second modality of testing be reviewed.

9. A system comprising:
a processor programmed to initiate executable operations comprising:
presenting a first list including a plurality of candidate first clinical findings that potentially correspond to a first modality of testing performed on a patient;
responsive to receiving a first user input selecting at least one of the candidate first clinical findings, selecting that candidate first clinical finding as a first clinical finding corresponding to the first modality of testing performed on the patient;
presenting a second list including a plurality of candidate second clinical findings that potentially correspond to a second modality of testing performed on the patient;
responsive to receiving a second user input selecting at least one of the candidate second clinical findings, selecting that candidate second clinical finding as a second clinical finding corresponding to the second modality of testing performed on the patient;
processing the first clinical finding and the second clinical finding to determine whether the first clinical finding and the second clinical finding clinically correlate; and
outputting an indication of whether the first clinical finding and the second clinical finding clinically correlate.

10. The system of claim 9, the executable operations further comprising:
responsive to determining the first clinical finding and the second clinical finding do not clinically correlate, processing the first clinical finding and the second clinical finding to determine a severity of a discrepancy between the first clinical finding and the second clinical finding; and
outputting an indication of the severity of the discrepancy between the first clinical finding and the second clinical finding.

11. The system of claim 9, the executable operations further comprising:
presenting a third list including a plurality of candidate third clinical findings that potentially correspond to the first clinical finding and to the first modality of testing performed on the patient;
responsive to receiving a third user input selecting at least one of the candidate third clinical findings, selecting that candidate third clinical finding as a third clinical finding corresponding to the first modality of testing performed on the patient;
presenting a fourth list including a plurality of candidate fourth clinical findings that potentially correspond to the second clinical finding and to the second modality of testing performed on the patient;
responsive to receiving a fourth user input selecting at least one of the candidate fourth clinical findings, selecting that candidate fourth clinical finding as a fourth clinical finding corresponding to the first modality of testing performed on the patient; and
processing the third clinical finding and the fourth clinical finding to determine whether the third clinical finding and the fourth clinical finding clinically correlate.

12. The system of claim 9, the executable operations further comprising:
presenting a third list including a plurality of candidate conditions that potentially correspond to the patient; and
receiving a third user input selecting at least one of the candidate conditions as a condition to be correlated between the first and second clinical findings;
wherein processing the first clinical finding and the second clinical finding to determine whether the first clinical finding and the second clinical finding clinically correlate comprises further processing the selected condition.

13. The system of claim 9, the executable operations further comprising:
presenting a third list including a plurality of candidate organs that potentially were tested during the first and second modalities of diagnostic testing performed on the patient; and
receiving a third user input selecting at least one of the candidate organs as an organ that was actually tested during the first and second modalities of diagnostic testing;
wherein:
presenting the first list including the plurality of candidate first clinical findings comprises identifying candidate clinical findings that potentially correspond to the selected organ; and
presenting the second list including the plurality of candidate second clinical findings comprises identifying candidate clinical findings that potentially correspond to the selected organ.

14. The system of claim 9, the executable operations further comprising:
presenting a third list including a plurality of candidate first modalities of diagnostic testing performed on the patient;
receiving a third user input selecting at least one of the candidate first modalities of diagnostic testing as the first modality of testing;
presenting a fourth list including a plurality of candidate second modalities of diagnostic testing performed on the patient; and
receiving a fourth user input selecting at least one of the candidate second modalities of diagnostic testing as the second modality of testing.

15. The system of claim 9, the executable operations further comprising:
based, at least in part, on the determination of whether the first clinical finding and the second clinical finding clinically correlate, determining whether the first modality of testing performed on the patient or the second modality of testing performed on the patient satisfies at least one guideline pertaining to the first modality of testing or at least one guideline pertaining the second modality of testing.

16. The system of claim 9, the executable operations further comprising:
based, at least in part, on a determination that the first clinical finding and the second clinical finding do not clinically correlate, automatically generating a recommendation that at least one procedure used to perform or analyze the first modality of testing or the second modality of testing be reviewed.

17. A computer program product comprising a computer-readable storage medium having program code stored thereon, the program code executable by a processor to perform a method comprising:
presenting a first list including a plurality of candidate first clinical findings that potentially correspond to a first modality of testing performed on a patient;
responsive to receiving a first user input selecting at least one of the candidate first clinical findings, selecting that candidate first clinical finding as a first clinical finding corresponding to the first modality of testing performed on the patient;
presenting a second list including a plurality of candidate second clinical findings that potentially correspond to a second modality of testing performed on the patient;
responsive to receiving a second user input selecting at least one of the candidate second clinical findings, selecting that candidate second clinical finding as a second clinical finding corresponding to the second modality of testing performed on the patient;
processing, using the processor, the first clinical finding and the second clinical finding to determine whether the first clinical finding and the second clinical finding clinically correlate; and
outputting an indication of whether the first clinical finding and the second clinical finding clinically correlate.

18. The computer program product of claim 17, the method further comprising:
responsive to determining the first clinical finding and the second clinical finding do not clinically correlate, processing the first clinical finding and the second clinical finding to determine a severity of a discrepancy between the first clinical finding and the second clinical finding; and
outputting an indication of the severity of the discrepancy between the first clinical finding and the second clinical finding.

19. The computer program product of claim 17, the method further comprising:
presenting a third list including a plurality of candidate third clinical findings that potentially correspond to the first clinical finding and to the first modality of testing performed on the patient;
responsive to receiving a third user input selecting at least one of the candidate third clinical findings, selecting that candidate third clinical finding as a third clinical finding corresponding to the first modality of testing performed on the patient;
presenting a fourth list including a plurality of candidate fourth clinical findings that potentially correspond to the second clinical finding and to the second modality of testing performed on the patient;
responsive to receiving a fourth user input selecting at least one of the candidate fourth clinical findings, selecting that candidate fourth clinical finding as a fourth clinical finding corresponding to the first modality of testing performed on the patient; and
processing the third clinical finding and the fourth clinical finding to determine whether the third clinical finding and the fourth clinical finding clinically correlate.

20. The computer program product of claim 17, the method further comprising:
presenting a third list including a plurality of candidate conditions that potentially correspond to the patient; and
receiving a third user input selecting at least one of the candidate conditions as a condition to be correlated between the first and second clinical findings;
wherein processing the first clinical finding and the second clinical finding to determine whether the first clinical finding and the second clinical finding clinically correlate comprises further processing the selected condition.
